(19) United States
(12) Patent Application Publication
(10) Pub. No.: US 2014/0323665 A1
(43) Pub. Date: Oct. 30, 2014

(54) Polyalphaolefins by Oligomerization and Isomerization

(71) Applicants: Margaret M. Wu, Skillman, NJ (US); Bernie J. Pafford, Houston, TX (US); Kevin B. Stavens, Houston, TX (US)

(72) Inventors: Margaret M. Wu, Skillman, NJ (US); Bernie J. Pafford, Houston, TX (US); Kevin B. Stavens, Houston, TX (US)

(73) Assignee: ExxonMobil Chemical Patents Inc., Baytown, TX (US)

(21) Appl. No.: 14/001,990

(22) PCT Filed: Feb. 28, 2012
(86) PCT No.: PCT/US12/26865

§ 371 Date: Nov. 11, 2013

Related U.S. Application Data
(60) Provisional application No. 61/469,457, filed on Mar. 30, 2011.

(51) Int. Cl. C08F 4/76

(52) U.S. Cl. CPC C08F 4/76
USPC 525/338; 526/131

(57) ABSTRACT

A feedstock of one or more C₄ to C₂₄ alpha olefins is oligomerized with a metallocene catalyst system to form a polyalphaolefin product mixture. At least a portion of the polyalphaolefin product mixture is then isomerized in the presence of an acid catalyst to form an isomerized polyalphaolefin. The polyalphaolefin may also by hydrogenated, either simultaneously with isomerization or afterwards. The resulting polyalphaolefin has a kinematic viscosity at 100° C. of between 1 cSt and 20 cSt and reduced pour point in comparison to the pre-isomerized product.

### PRIORITY CLAIM

This application claims the benefit of and priority to U.S. Provisional Application No. 61/469,457, filed Mar. 30, 2011.

### FIELD OF THE INVENTION

The invention relates to the oligomerization of olefins, in particular linear alpha-olefins, using metallocene catalysts and isomerization of the polyalphaolefins (“PAOs”) obtained from the oligomerization.

### BACKGROUND OF THE INVENTION

Efforts to improve on the performance of natural mineral oil-based lubricants by the synthesis of oligomeric hydrocarbon fluids have been the subject of important research and development in the petroleum industry for at least fifty years. These efforts have led to the relatively recent market introduction of a number of synthetic lubricants.

In terms of lubricant property improvement, the thrust of industrial research efforts involving synthetic lubricants has been towards fluids exhibiting useful viscosities over a wide temperature range, i.e., improved viscosity index (VI), while also showing lubricities, thermal stabilities, oxidative stabilities and pour points equal to or better than those for mineral oil.

The viscosity-temperature relationship of a lubricating oil is one of the main criteria considered when selecting a lubricant for a particular application. The mineral oils, commonly used as a base for single and multi-grade lubricants, exhibit a relatively large change in viscosity with a change in temperature. Fluids exhibiting such a relatively large change in viscosity with temperature are said to have a low VI. VI is an empirical number which indicates the rate of change in the viscosity of an oil within a given temperature range. A high VI oil, for example, will thin out at elevated temperatures more slowly than a low VI oil. Usually, a high VI oil is more desirable because it has relatively higher viscosity at higher temperature, which translates into better lubrication and better protection of the contacting machine elements, preferably at high temperatures and/or at temperatures over a wide range. VI is calculated according to ASTM method D 2270.

PAOs comprise a class of hydrocarbons manufactured by the catalytic oligomerization (polymerization to low-molecular-weight products) of linear alpha-olefin (LAO) monomers. These typically range from 1-octene to 1-dodecene, with 1-decene being a preferred material, although oligomeric copolymers of lower olefins such as ethylene and propylene may also be used, including copolymers of ethylene with higher olefins as described in U.S. Pat. No. 4,956,122 and the patents referred to therein.

PAO products have achieved importance in the lubricating oil market. Typically there are two classes of synthetic hydrocarbon fluids (SHF) produced from LAOs, the two classes of SHF being denoted as PAO and HVI-PAO (high viscosity index PAOs). PAOs of different viscosity grades are typically produced using promoted BF₃ or AlCl₃ catalysts.

Specifically, PAOs may be produced by the polymerization of olefin feed in the presence of a catalyst such as AlCl₃, BF₃, or promoted AlCl₃, BF₃. These catalysts show reactivity toward branched olefins but exhibit higher reactivity toward alpha-olefins. When oligomerizing a feed of LAOs with these catalysts, a process-generated side stream of unreacted monomers is produced. Recycling these unreacted monomers is considered disadvantageous because they contain branched or internal olefins which typically are not desired in the production of conventional PAOs since they have adverse effect on final PAO product properties and impact the reactor capacity.

Processes for the production of PAOs using metallocene catalysts in the oligomerization of various alpha-olefin feeds have been previously disclosed in PCT/US2006/027591, PCT/US2006/021231, PCT/US2006/027943, and PCT/2007/010215, all of which provide additional background, explicitly or through citation of references, for the present invention. Ideally, it is desirable to convert all the alpha-olefin feeds into lube products. However, sometimes, in order to optimize reactor efficiency and reactor capacity, it is desirable to keep the reaction at partial olefin conversion, less than 100% alpha-olefin conversion. Typically the amount of alpha-olefin monomer converted into lubricant-range PAOs is less than 80 mol %.

Additionally, performance requirements of lubricants are becoming increasingly stringent. New PAOs with improved properties, such as high VI, low pour point, reduced volatility, high shear stability, narrow molecular weight distribution, improved wear performance, increased thermal stability, oxidative stability, and/or wider viscosity range, are needed to meet new performance requirements for lubricants. New methods to provide such new PAOs with improved properties are also needed.

Prior specific efforts to prepare various PAOs using particular metallocene catalyst systems include U.S. Pat. No. 6,706,828, where PAOs are produced from racemic forms of certain metallocene catalysts, such as rac-dimethylsilylbis(2-methyl-indenyl)zirconium dichloride in combination with methylalumoxane (MAO) at 100° C. in the presence of hydrogen to produce polydecene; WO 02/14384, which discloses, among other things, in examples J and K the use of rac-ethyl-bis(indenyl)zirconium dichloride or rac-dimethylsilyl-bis(2-methyl-indenyl) zirconium dichloride in combination with MAO at 40° C. (at 200 psi hydrogen or 1 mole of hydrogen) to produce isotactic polydecene reportedly having a glass transition temperature (Tg) of −73.8° C., a kinematic viscosity at 100° C. (KV₁₀₀) of 702 cSt, and a VI of 296; or to produce polydecene reportedly having a Tg of −66° C., a KV₁₀₀ of 1624, and a VI of 341, respectively; and WO 99/67347, which discloses, for example, in Example 1 the use of ethylidene bis(tetrahydroindenyl)zirconium dichloride in combination with MAO at 50° C. to produce a polydecene reportedly having an Mₙ of 11,400 and 94% vinylidene double bond content.

PAOs have also been made using metallocene catalysts not typically known to produce polymers or oligomers with any specific tacticity. Examples include WO 96/23751; EP 0 613 873; U.S. Pat. No. 5,688,887; U.S. Pat. No. 6,043,401; WO 03/020856 (equivalent to US 2003/0055184); U.S. Pat. No. 5,087,788; U.S. Pat. No. 6,414,090; U.S. Pat. No. 6,414,091; U.S. Pat. No. 4,704,491; U.S. Pat. No. 6,133,209; and U.S. Pat. No. 6,713,438.

Additionally, U.S. Pat. Nos. 6,548,723 and 6,548,724 disclose production of oligomer oils using certain metallocene catalysts, typically in combination with methyl alumoxane.

In other examples, WO 2007011459 A1 describes the production of liquids from monomers having 5 to 24 carbon atoms using metallocenes and non-coordinating anion activators, and WO 2007011973 A1 describes the production of low viscosity liquids from alpha-olefins using metallocenes.

Although metallocene catalysts are effective in producing oligomers as high performance fluids after hydrogenation, sometimes, the fluids have less desirable low temperature properties, as measured by pour point. This is especially the case when the oligomers contain high amounts of dimers from C8 to C30 LAOs. Oligomers containing high amounts of dimers often have very high pour points, either before or after hydrogenation. Their high pour points prevent the fluids from high performance applications or wide temperature range applications.

### SUMMARY OF THE INVENTION

The invention is directed to a process for the preparation of PAOs in the presence of a metallocene catalyst, the improvement comprising a process to produce oligomers with high dimer content and significantly improved pour points and low temperature viscometrics, such as kinematic viscosity at −40° C. (KV₄₀), cold crank simulator results (CCS), etc.

Disclosed herein is a process to prepare a PAO having a KV₁₀₀ of between 1 cSt and 20 cSt. In the process, a metallocene catalyst system is contacted with a feedstock comprising one or more monomers selected from C₄ to C₂₄ alpha-olefins to form a PAO product mixture. Then at least a portion of the PAO product mixture is isomerized in the presence of an acid catalyst to form an isomerized PAO.

In one embodiment of the invention, the isomerized PAO may be hydrogenated. When hydrogenation of the product is desired, in one embodiment of the invention, the isomerization and the hydrogenation may be integrated and performed in a single step using one catalyst to simultaneously achieve both isomerization and hydrogenation.

In one embodiment of the invention, the feedstock consists of at least two alpha-olefin monomers selected from 1-butene, 1-hexene, 1-octene, 1-nonene, 1-decene, 1-dodecene, 1-tetradecene, 1-hexadecene, and 1-octadecene. Alternatively, the feedstock may be a single monomer, and in one embodiment of the invention, such a single monomer feedstock may be selected from the group consisting of 1-octene, 1-nonene, 1-decene, 1-dodecene, and 1-tetradecene.

In one embodiment of the invention, the isomerization acid catalyst is selected from the group consisting of zeolites, Friedel-Crafts catalysts, Bronsted acids, Lewis acids, acidic resins, acidic solid oxides, acidic silicoaluminophosphates, Group IVB metal oxides, Group VB metal oxides, Group VIB metal oxides, hydroxide or free metal forms of Group VIII metals, and any combination thereof. In one embodiment of the invention, the acid catalyst is a zeolite catalyst having a Constraint Index of about 12 or less.

In one embodiment of the invention, the process may include the step of fractionating the PAO product mixture to obtain a portion of the mixture wherein the portion is at least 80 wt % dimer of the feedstock monomers.

In one embodiment of the invention, by isomerizing at least a portion of the PAO product mixture, the pour point of the isomerized PAO is at least 20° C. less than prior to isomerization.

### DETAILED DESCRIPTION OF THE INVENTION

According to the invention, PAOs are produced by a process comprising contacting a metallocene catalyst in the presence of an NCA and co-activator and/or scavenger with a monomer feed comprising alpha-olefins, to obtain low viscosity PAOs, in particular PAOs having a KV₁₀₀ ranging from 1.0 to 20 cSt. This improved process is especially useful to produce 1.5 to 10 cSt fluids from LAO dimers or from oligomers rich in LAO dimers. The low viscosity fluids of 3 cSt or less with low pour points are useful in the formulation of specialty, fuel/energy efficient engine, transmission, or hydraulic fluids, etc. The low viscosity fluids in the range of 3 to 20 cSt may be useful as high performance, fuel/energy efficient base stocks.

For these high performance applications, it is important that the fluids have excellent viscometrics (high VI) and low pour points and low low-temperature viscosities, as measured by KV₄₀, low temperature Brookfield viscometers, or CCS results, etc.

In the disclosed process, the results is oligomers with high dimer content having low pour points and favorable low temperature viscometrics. In the process, C₄ to C₂₄ alpha-olefins, preferably LAOs, either individually or a mixture of them, are first polymerized using a metallocene catalyst system to produce oligomers that are high in dimer content. The dimer fraction, either separated from the remaining higher oligomers or together with the higher oligomers (the whole product fractions), is then passed through an acidic isomerization catalyst. The isomerized oligomers have improved low temperature properties, as measured by the pour points. These isomerized oligomers can be further hydrogenated over a typical PAO hydrogenation catalyst, such as a nickel on kieselguhl catalyst. Alternatively, the isomerization and hydrogenation step can be carried out simultaneously or using one catalyst. This isomerized-hydrogenated fluid has significantly improved pour point and other low temperature properties. In this integrated process, the isomerization and hydrogenation step is used to replace the simple hydrogenation step.

In one embodiment of the invention, the feed is selected from one or at least one of C₄ to C₂₄ alpha-olefin monomers. In a preferred embodiment of the invention, the feed is selected from at least two different monomers selected from C₆ to C₁₈ alpha-olefin monomers. In another preferred embodiment of the invention, the feed is selected from at least three different monomers selected from C₆ to C₁₈ alpha-olefin monomers.

### Feedstocks

The feedstocks useful for oligomerization are C₄ to C₂₄ olefin monomers, preferably alpha-olefins. The C₄ to C₂₄ olefins are preferably LAO monomers; the reduced branching of such monomers produces more desirable properties in the final product. Useful in the process of the invention are single alpha-olefins and any mixtures of any alpha-olefins in the range of C₄ to C₂₄.

In one embodiment of the invention, the process utilizes mixed alpha-olefins (i.e., at least two different alpha-olefins, or at least three different alpha-olefins) as a feed; however the use of a single alpha-olefin selected from the group of C₆ to C₁₈ alpha-olefins is also an alternative embodiment of the invention. When using a single monomer feedstock, alpha-olefins that produce highly favorable lubricant basestock products are 1-octene, 1-nonene, 1-decene, 1-dodecene, and 1-tetradecene. In a preferred embodiment of the invention, the feeds include at least two alpha-olefin monomers selected from 1-butene, 1-hexene, 1-octene, 1-nonene, 1-decene, 1-dodecene, 1-tetradecene, 1-hexadecene, and 1-octadecene.

These alpha-olefins may be obtained from any conventional source, including being derived from an ethylene growth process, from Fischer-Tropsch synthesis, from steam or thermal cracking processes, syn-gas synthesis, C₄ stream containing 1-butene from refinery operation, such as Raff-1 or Raff-2 stream, and so forth.

### Catalyst System

The catalyst system comprises a metallocene compound together with the activator. The catalyst may be bridged or unbridged, and it may be meso-, racemic-, or contain other symmetry groups. For the purpose of this invention, the term “catalyst system” includes the single site metallocene compound and activator pair. When “catalyst system” is used to describe such a pair before activation, it means the unactivated catalyst (precatalyst) together with an activator and, optionally, a co-activator (such as a trialkyl aluminum compound). When it is used to describe such a pair after activation, it means the activated catalyst and the activator or other charge-balancing moiety. Furthermore, this activated “catalyst system” may optionally comprise the co-activator and/or other charge-balancing moiety.

Catalysts suitable for the process of the present invention include single-site metallocene catalyst systems, such as described in WO 2007/011832; WO 2007/011459; and WO 2007/011973. The preferred metal is selected from Group 4 transition metals, preferably zirconium (Zr), hafnium (Hf), and titanium (Ti).

Preferred single-site catalysts for the present invention include catalysts such as rac-dimethyl-silyl-bis(4,5,6,7-tetrahydroindenyl) zirconium dichloride or rac-dimethyl-silyl-bis(4,5,6,7-tetrahydroindenyl) zirconium dimethyl, rac-dimethyl-silyl-bis(indenyl) zirconium dichloride or rac-dimethyl-silyl-bis(indenyl) zirconium dimethyl, rac-ethylidene-bis(4,5,6,7-tetrahydroindenyl) zirconium dichloride or rac-ethylidene-bis(4,5,6,7-tetrahydroindenyl) zirconium dimethyl, rac-ethylidene-bis(indenyl) zirconium dichloride or rac-ethylidene-bis(indenyl) zirconium dimethyl, meso-dimethyl-silyl-bis(4,5,6,7-tetrahydroindenyl) zirconium dichloride or meso-dimethyl-silyl-bis(4,5,6,7-tetrahydroindenyl) zirconium dimethyl, meso-dimethyl-silyl-bis(indenyl) zirconium dichloride or meso-dimethyl-silyl-bis(indenyl) zirconium dimethyl, meso-ethylidene-bis(4,5,6,7-tetrahydroindenyl) zirconium dichloride or meso-ethylidene-bis(4,5,6,7-tetrahydroindenyl) zirconium dimethyl, meso-ethylidene-bis(indenyl) zirconium dichloride or meso-ethylidene-bis(indenyl) zirconium dimethyl. Other preferred single-site catalysts include the aforementioned racemic or meso catalysts with different degrees of substituted indenyl ligands.

Other preferred metallocenes include the unbridged metallocenes such as bis(cyclopentadienyl) zirconium dichloride, bis(cyclopentadienyl) zirconium dimethyl, bis(1,2-dimethylcyclopentadienyl) zirconium dichloride, bis(1,2-dimethylcyclopentadienyl) zirconium dimethyl, bis(1,3-dimethylcyclopentadienyl) zirconium dichloride, bis(1,3-dimethylcyclo-pentadienyl) zirconium dimethyl, bis 1,2,3-trimethylcyclopentadienyl) zirconium dichloride, bis(1,2,3-trimethylcyclopentadienyl) zirconium dimethyl, bis(1,2,4-trimethylcyclopentadienyl) zirconium dichloride, bis(1,2,4-trimethylcyclopentadienyl) zirconium dimethyl, bis(1,2,3,4-tetramethylcyclopentadienyl) zirconium dichloride, bis(1,2,3,4-tetramethylcyclopentadienyl) zirconium dimethyl, bis(pentamethylcyclo-pentadienyl) zirconium dichloride, bis(pentamethyl-cyclopentadienyl) zirconium dimethyl, and other substituted analogs.

### Activator

The activator may be an NCA activator or a trialkyl aluminum compound, such as methylaluminoxane (MAO). For purposes of this invention and the claims thereto, an NCA is defined to mean an anion which either does not coordinate to the catalyst metal cation or that coordinates only weakly to the metal cation. An NCA coordinates weakly enough that a neutral Lewis base, such as an olefinically or acetylenically unsaturated monomer, can displace it from the catalyst center. Any metal or metalloid that can form a compatible, weakly coordinating complex with the catalyst metal cation may be used or contained in the NCA. Suitable metals include, but are not limited to, aluminum, gold, and platinum. Suitable metalloids include, but are not limited to, boron, aluminum, phosphorus, and silicon. A subclass of NCAs comprises stoichiometric activators, which can be either neutral or ionic. The terms ionic activator, and stoichiometric ionic activator can be used interchangeably. Likewise, the terms neutral stoichiometric activator and Lewis acid activator can be used interchangeably.

A preferred activator for the present invention is an NCA, preferably such as described in U.S. Pat. No. 7,279,536, or in WO 2007/011832. In some embodiments of the invention, the catalyst system specifically excludes the use of an oxygen containing compound such as aluminoxanes, and specifically excludes MAO. The more preferred NCA is C₃₂H₁₂BF₂₀N (n,n-dimethylanilinium tetrakis(penta-fluorophenyl) borate.

The catalyst system may also include a co-activator, such as a trialkylaluminum compound. This trialkyl aluminum compound can also be used effectively as an impurity or poison scavenger for the reactor system. Preferred trialkyl aluminum compounds are tri-isobutylaluminum, tri-n-octylaluminum or tri-n-hexylaluminum or tri-n-decylaluminum, tri-n-octylaluminum, etc.

Other components used in the reactor system can include inert solvent, catalyst diluent, etc. These components can also be recycled during the operation.

### Product Oligomerization

When the polymerization or oligomerization reaction is progressed to the pre-determined stage, such as 70% or 80% or 90% or 95% alpha-olefin conversion, the reactor effluent is withdrawn from the reactor. Usually the reaction product should be treated in the same manner as described in U.S. Patent Application Publication No. 2008/0020928. In the preferred manner, the catalyst should be deactivated by introduction of air, CO₂ or water or other deactivator to a separate reaction vessel. The catalyst components can be removed by methods described in the aforementioned U.S. Patent Application Publication No. 2008/0020928 or by washing with aqueous base or acid followed by separating the organic layer as in conventional catalyst separation method. After the catalyst removal, the effluent can be subjected to a distillation to separate the un-reacted feed olefins, inert solvents and other lighter components from the heavier oligomerization product. Depending on the polymerization reaction conditions, this oligomerization product may have a high degree of unsaturation as measured by bromine number (ASTM D1159 method or equivalent method). If the bromine number is too high, the heavy oligomer fraction is subjected to a hydrofinishing step to reduce the bromine number, usually to less than 3 or less than 2 or less than 1, depending on hydrofinishing conditions and the desired application of the PAO base stock. Typical hydrogenation step can be found in many published patents and literatures of PAO production process. Sometimes, when hydrogen is used during the polymerization step, the isolated PAO products will naturally have a very low bromine number or degree of unsaturation, the product can be used directly in many applications without a separate hydrogenation step.

When producing low viscosity PAO, oligomerization of the feedstock monomers will yield a polyolefin product mixture containing a certain percentage of dimer of the feedstock monomers. The amount of dimer may vary, ranging anywhere from 5 wt % to greater than 70 wt % of the total polyolefin product. In some embodiments of the invention, it may be desired to oligomerize the monomer to produce only dimer. In accordance with the present invention, the amount of dimer will be in the range of 5 to 80 wt %, 5 to 70 wt %, 20 to 70%, or 25 to 65 wt %. For some end-use applications, dimer product does not provide the desired pour point characteristics and other properties. This dimer, or light fraction, may be separated directly from the reactor effluent or further fractionated from a light fraction that also contains un-converted alpha-olefins. This light fraction can be recycled with or without any purge, into the polymerization reactor for further conversion into lube product. However, if the amount of dimer to be recycled increases, it is more advantageous to otherwise convert the dimer into a useful lubricant basestock product via an isomerization.

### Isomerization

Distinct from the oligomerization step described above, after the olefin monomers are oligomerized, the resulting dimer fraction, or the dimer fraction along with any or all of the remaining portions of the oligomerized product, is subjected to isomerization. The feedstream to the isomerization reactor contains at least 50 wt % dimer of the oligomerization feedstock monomers; preferably, the isomerization feedstream is at least 80 wt % dimer of the oligomerization feedstock monomers.

Isomerization is distinct from the oligomerization as the reaction does not result in two or more of the individual polymers bonding together, but is instead a rearrangement of the structure of the product; i.e., movement of double bonds or branching locations of the product. Because one potential isomerization is the movement or removal of any remaining double bonds, the product may be hydrogenated simultaneously during isomerization. For purposes herein, an isomerized PAO is defined as a PAO that after isomerization has a pour point at least 20° C. less than the same PAO prior to the isomerization process.

The catalytic isomerization conditions, such as temperature and pressure, depend upon the feed stock employed and the desired pour point of the lube produced. Generally, isomerization occurs at a temperature in a range between about 150° C. to about 475° C.; however, higher or lower temperatures may be employed. In another embodiment of the invention, isomerization occurs at a temperature in a range between about 200° C. to about 450° C. Pressure is typically from about 0.07 MPa to 13.8 MPa (1 psi to 2000 psi), but higher or lower pressures may be employed. In another embodiment of the invention, the pressure is between about 0.07 MPa to 6.89 MPa (10 psi to 1000 psi). Yet, in another embodiment of the invention, the pressure is between about 0.69 MPa to 4.14 MPa (100 psi to 600 psi).

An acid catalyst is a preferred isomerization catalyst. Examples of such acid catalysts invention include, but are not limited to, zeolites; homogeneous acid catalysts, such as Friedel-Crafts catalysts, Bronsted acids, and Lewis acids; acidic resins; acidic solid oxides; acidic silicoaluminophosphates; Group IVB, VB, and VIB metal oxides; hydroxide or free metal forms of Group VIII metals; and any combination thereof. Additionally, acid catalysts having an alpha value of at least about 1 may be employed in the isomerization reaction.

In a preferred embodiment of the invention, a zeolite, modified zeolites, or combination of zeolites, are employed in the process of the present invention. Preferred zeolites include, but are not limited to, a medium- or large-pore size zeolite. Preferred zeolites have a constraint index as defined herein of about 12 or less. Zeolites having a constraint index of 2-12 are generally regarded to be medium-pore size zeolites. Zeolites having a constraint index of less than 1 are generally regarded to be large-pore size zeolites. A characteristic of the crystal structure of this class of zeolites is that it provides a selective constrained access to, and egress from, the intra-crystalline free space by virtue of having an effective pore size between the small pore Linde A and the large pore Linde X, i.e., the pore windows of the structure are of about a size such as would be provided by 10-membered rings of silicon atoms interconnected by oxygen atoms. It is to be understood that these rings are those formed by the regular disposition of the tetrahedra making up the anionic framework of the crystalline aluminosilicate, the oxygen atoms themselves being bonded to the silicon (or aluminum, etc.) atoms at the centers of the tetrahedra. For a detailed discussion of how to measure the constraint index of a zeolite, see U.S. Pat. No. 7,456,329. Briefly, in one embodiment of the invention, zeolites useful as catalysts in this invention possess, in combination: a “constraint index” (defined hereinafter) of from about 1 to about 12; a silica to alumina ratio of at least about 12; and a structure providing a selective constrained access to the crystalline free space.

The silica to alumina mole ratio may be determined by conventional analysis. This ratio represents the silica to alumina ratio in the rigid anionic framework of the zeolite crystal and excludes aluminum which is present in the binder or which is present in cationic or other form within the channels. Zeolites with silica to alumina mole ratios of at least 12 may be employed in the present invention. In another embodiment of the invention, zeolites having silica to alumina mole ratios of at least about 30 may be employed. In yet another embodiment of the invention, in some instances, zeolites having substantially higher silica/alumina ratios, e.g., 1600 and above, may be employed.

Zeolites useful herein typically have an effective pore size of generally from about 5 to about 8 Angstroms, such as to freely sorb normal hexane. In addition, the structures provide constrained access to larger molecules. It is sometimes possible to estimate from a known crystal structure whether such constrained access exists. For example, if the only pore windows in a crystal are formed by 8-membered rings of silicon and aluminum atoms, then access by molecules of larger cross-section than normal hexane is generally excluded and the zeolite may not be of the desired type. Windows of 10-membered rings generally may be employed with the process of the present invention. Also, 12-membered rings having constrained access may be employed with the process of the present invention. For example, the puckered 12-ring structure of TMA (tetramethyl ammonium) offretite, does show some constrained access.

The constraint index values typically used to characterize the specified zeolites described below (including some zeolites not specifically identified), are a cumulative result affected by several variables. Thus, for a given zeolite exhibiting a constraint index value within the range of about 1 to about 12, depending on the test temperature and conversion between 10% and 60%, the constraint index may vary within the indicated approximate range of 1 to 12. Likewise, other variables such as the crystal size of the zeolite, the presence of possibly occluded contaminants and binders intimately combined with the zeolite may affect the constraint index. It will accordingly be understood by those skilled in the art that the constraint index, while affording a highly useful means for characterizing the zeolites of interest, is dependent on the test conditions. However, in all instances, at a temperature within the above-specified range of 288° C. to 510° C. (550° F. to 950° F.), the constraint index will have a value for any given zeolite of interest herein within the approximate range of 1 to 12.

Constraint index (CI) values for some typical materials are:

TABLE 1

| Catalyst | CI (at test temperature) |
|---|---|
| ZSM-4 | 0.5 (316° C.) |
| ZSM-5 | 6-8.3 (371° C.-316° C.) |
| ZSM-11 | 5-8.7 (371° C.-316° C.) |
| ZSM-12 | 2.3 (316° C.) |
| ZSM-20 | 0.5 (371° C.) |
| ZSM-22 | 7.3 (427° C.) |
| ZSM-23 | 9.1 (427° C.) |
| ZSM-34 | 50 (371° C.) |
| ZSM-35 | 4.5 (454° C.) |
| ZSM-38 | 2.0 (427° C.) |
| ZSM-48 | 3.5 (538° C.) |
| ZSM-50 | 2.1 (427° C.) |
| TMA Offretite | 3.7 (316° C.) |
| TEA Mordenite | 0.4 (316° C.) |
| Clinoptilolite | 3.4 (510° C.) |
| Mordenite | 0.5 (316° C.) |
| REY | 0.4 (316° C.) |
| Amorphous Silica-Alumina | 0.6 (538° C.) |
| Dealuminized Y | 0.5 (510° C.) |
| Erionite | 38 (316° C.) |
| Zeolite Beta | 0.6-2.0 (316° C.-399° C.) |

The above-described constraint index is a generally useful parameter for identifying those zeolites which may be employed in the instant invention. Therefore, it will be appreciated that it may be possible to so select test conditions, e.g., temperature, as to establish more than one value for the constraint index of a particular zeolite. This explains the range of constraint indices for some zeolites, such as ZSM-5, ZSM-11 and Beta.

One group of zeolites contemplated herein is exemplified, but not limited to, by ZSM-5, ZSM-11, ZSM-12, ZSM-22, ZSM-23, ZSM-35, ZSM-38, and ZSM-48.

Large-pore zeolites, including those zeolites having a constraint index less than 2, are well known in the art and have a pore size sufficiently large to admit the vast majority of components normally found in a feed chargestock. The large-pore zeolites are generally stated to have a pore size in excess of 6 Angstroms and are represented by zeolites having the structure of, e.g., Zeolite Beta, Zeolite UHP-Y, Zeolite Y, Ultrastable Y (USY), Dealuminized Y, Mordenite, ZSM-3, ZSM-4, ZSM-14, ZSM-18, and ZSM-20. A crystalline silicate zeolite well known in the art and also useful in the present invention is faujasite. The ZSM-20 zeolite resembles faujasite in certain aspects of structure, but has a notably higher silica/alumina ratio than faujasite, as does Dealuminized Y.

Accordingly, in one embodiment of the invention, the catalyst may comprise or further comprise a homogeneous acid catalyst; an acidic resin; an acidic solid oxide; an acidic silicoaluminophosphate; a Group IVB metal oxide; an oxide of a Group VIII, IVA, or VB metal; a hydroxide of a Group VIII, IVA, or VB metal; a free metal of a Group VIII, IVA, or VB metal; or any combination thereof.

In one embodiment of the invention, the acid catalyst is a zeolite containing one or more Group VI B to VIIIB metal elements. In another embodiment of the invention, the acid catalyst is a zeolite containing one or more metals selected from the group consisting of Pt, Pd, Ni, Co, Rh, Ir, Ru, W, Mo, and a combination thereof.

In general, homogeneous acid catalysts may be employed for the isomerization process to improve the low temperature properties of the lube base stocks. The types of homogenous catalysts include Friedel-Crafts catalysts, Bronsted acids, and Lewis acids. Examples are boron halides (BF₃, BCl₃, BBr₃), aluminum halides (AlCl₃, AlBr₃), SbF₅, TiCl₃, TiCl₄, SnCl₄, PF₅, SnF₄, H₂SO₄, HCOOH, HF, HCl, HBr, triflic acid, and the like. These homogeneous acids can be mixed with the feed lube base stocks and heated to a temperature sufficient to cause the isomerization reaction to produce the isomerized PAO. When the reaction is complete, the homogenous catalyst can be removed by washing with water and/or with dilute aqueous acid or base, and separating the aqueous layer from the organic lube composition. If necessary and/or desired, the lube composition can then be hydrogenated to remove unsaturation in the polymer. The finished lube will generally exhibit excellent low temperature properties.

In addition to solid zeolitic material for use as catalyst, other types of solid acidic catalysts can also be used. Examples include, but are not limited to, acidic resins, such as acidic ion-exchange resins (AMBERLITE IR 120 PLUS™, AMBERLITE IRC-50™, AMBERLITE IRP-69™, AMBERLYST 15™, AMBERLYST 36™, DOWEX 50W™ series, DOWEX HCR-W2™, DOWEX 650C™, DOWEX MARATHON C™, DOWEX DR-2030™, NAFION™ series), and the like. When solid ion-exchange resins are employed as catalysts, the processing steps can be similar as in zeolite catalysts. They can be used in fixed bed, slurry reactor, or CSTR-type reactor.

Acidic solid oxides may also be employed as an isomerization catalyst in the present invention. A particular acidic solid oxide which may be employed in one embodiment of the invention is MCM-36. MCM-36 is a pillared layered material having zeolitic layers. Additionally, MCM-22, MCM-49, MCM-56, and MCM-68 are useful acidic solid oxides for catalyzing the isomerization reaction of the present invention. MCM-56 is a layered material having a composition involving the molar relationship:

X₂O₃:(n)YO₂,

wherein X is a trivalent element, such as aluminum, boron, iron, and/or gallium; Y is a tetravalent element such as silicon and/or germanium; and n is less than about 35, e.g., from about 5 to less than about 25, usually from about 10 to less than about 20, more usually from about 13 to about 18. In the as-synthesized form, the material has a formula, on an anhydrous basis and in terms of moles of oxides per n moles of YO₂, as follows:

(0-2)M₂O:(1-2)R:X₂O₃:(n)YO₂,

wherein M is an alkali or alkaline earth metal, and R is an organic moiety. The M and R components are associated with the material as a result of their presence during synthesis, and are easily removed by post-synthesis as described in U.S. Pat. No. 5,600,048.

The MCM-56 material may be thermally treated and in the calcined form exhibits high surface area (greater than 300 m²/gm) and unusually large sorption capacity for certain large molecules when compared to materials such as calcined PSH-3, SSZ-25, MCM-22, and MCM-49, all of which are described in U.S. Pat. No. 5,600,048. The MCM-56 wet cake, i.e., as-synthesized MCM-56, is swellable indicating the absence of interlayer bridges, in contrast with MCM-49 which is unswellable.

To the extent desired, the original alkali or alkaline earth, e.g., sodium, cations of the as-synthesized material can be replaced in accordance with techniques well known in the art, at least in part, by ion exchange with other cations. Replacement cations include metal ions, hydrogen ions, hydrogen precursor, e.g., ammonium, ions, and mixtures thereof. Further, replacement cations include cations which tailor the catalytic activity for certain hydrocarbon conversion reactions. These include hydrogen, rare earth metals, and metals of Groups IIA, IIIA, IVA, IB, IIB, IIIB, IVB, and VIII of the Periodic Table of the Elements.

The acidic solid oxide crystals can be shaped into a wide variety of particle sizes. Generally speaking, the particles can be in the form of a powder, a granule, or a molded product such as an extrudate having a particle size sufficient to pass through a 2 mesh (Tyler) screen and be retained on a 400 mesh (Tyler) screen. In cases where the catalyst is molded, such as by extrusion, the crystals can be extruded before drying or partially dried and then extruded.

The acidic solid oxide crystalline material may be composited with another material which is resistant to the temperatures and other conditions employed in the process of this invention. Such materials include active and inactive materials and synthetic or naturally occurring zeolites as well as other inorganic materials such as clays and/or oxides such as alumina, silica, silica-alumina, zirconia, titania, magnesia, or mixtures of these and other oxides. Such inorganic oxides may be either naturally occurring or in the form of gelatinous precipitates or gels including mixtures of silica and metal oxides.

Clays may also be included with the oxide type binders to modify the mechanical properties of the catalyst or to assist in its manufacture. Use of a material in conjunction with the acidic solid crystal, i.e., combined therewith or present during its synthesis, which itself is catalytically active may change the conversion and/or selectivity of the catalyst. Inactive materials may serve as diluents to control the amount of conversion so that products can be obtained economically and without employing other means for controlling the rate of reaction. These materials may be incorporated into naturally occurring clays, e.g., bentonite and kaolin, to improve the crush strength of the catalyst under commercial operating conditions and to function as binders or matrices for the catalyst.

The relative proportions of finely divided solid acid and crystalline material and inorganic oxide matrix vary widely, with the solid acid crystal content ranging from about 1 to about 90 percent by weight and more usually, particularly when the composite is prepared in the form of beads, in the range of about 2 to about 80 weight percent of the composite.

An intermediate pore size acidic silicoaluminophosphate may be employed as an isomerization catalyst in one embodiment of the present invention. Examples of such silicoaluminophosphates include, but are not limited to SAPO-11, SAPO-31, and SAPO-41. Optionally, the silicoaluminophosphates may be combined with a platinum or palladium component. SAPO-11 is an intermediate pore size silicoaluminophosphate acidic molecular sieve; the SAPO-11 intermediate pore size silicoaluminophosphate molecular sieve comprises a molecular framework of corner-sharing (SiO₂) tetrahedra, (AlO₂) tetrahedra, and ([PO₂) tetrahedra [i.e., (SiₓAl_{y}P)O₂ tetrahedral units]. SAPO-31 is an intermediate pore size silicoaluminophosphate acidic molecular sieve having a three-dimensional microporous crystal framework of (PO₂), (AlO₂), and (SiO₂). SAPO-41 is an intermediate pore size silicoaluminophosphate acidic molecular sieve having a three-dimensional microporous crystal framework structure of (PO₂), (AlO₂), and (SiO₂) tetrahedral units.

Another type of solid acidic catalyst which may be employed as the isomerization catalyst comprises a Group IVB metal oxide, such as zirconia or titania, modified with an oxyanion of an Group VIB metal, such as an oxyanion of tungsten, such as tungstate. The modification of the Group IVB metal oxide with the oxyanion of the Group VIB metal is believed to impart acid functionality to the material. An example of a modification of a Group IVB metal oxide, particularly, zirconia, with a Group VIB metal oxyanion, particularly tungstate, is described in U.S. Pat. No. 5,113,034.

For the purposes of the present disclosure, the expression, Group IVB metal oxide modified with an oxyanion of a Group VIB metal, is intended to connote a material comprising a Group VIB metal, and oxygen, with more acidity than a simple mixture of separately formed Group IVB metal oxide mixed with a separately formed Group VIB metal oxide or oxyanion. Although not wishing to be bound by any particular theory, the present Group IVB metal, e.g., zirconium, oxide modified with an oxyanion of a Group VIB metal, e.g., tungsten, is believed to result from an actual chemical interaction between a source of a Group IVB metal oxide and a source of a Group VIB metal oxide or oxyanion.

Other elements, such as alkali (Group IA) or alkaline earth (Group IIA) compounds may optionally be added to the present catalyst to alter catalytic properties. The addition of such alkali or alkaline earth compounds to the present catalyst may enhance the catalytic properties of components thereof, e.g., Pt or W, in terms of their ability to function as a hydrogenation/dehydrogenation component or an acid component.

The Group IVB metal (i.e., Ti, Zr or Hf) and the Group VIB metal (i.e., Cr, Mo, or W) species of the present catalyst are not limited to any particular valence state for these species. These species may be present in this catalyst in any possible positive oxidation value for these species. Subjecting the catalyst, e.g., when the catalyst comprises tungsten, to reducing conditions, e.g., sufficient to reduce the valence state of the tungsten, may enhance the overall catalytic ability of the catalyst to catalyze certain reactions, e.g., the isomerization of n-hexane.

Suitable sources of the Group IVB metal oxide, used for preparing the modified Group IVB metal oxide catalyst, include compounds capable of generating such oxides, such as oxychlorides, chlorides, nitrates, etc., particularly of zirconium or titanium. Alkoxides of such metals may also be used as precursors or sources of the Group IVB metal oxide. Examples of such alkoxides include, but are not limited to, zirconium n-propoxide and titanium i-propoxide. Preferred sources of a Group IVB metal oxide are zirconium hydroxide, i.e., Zr(OH)₄, and hydrated zirconia. The expression, hydrated zirconia, is intended to connote materials comprising zirconium atoms covalently linked to other zirconium atoms via bridging oxygen atoms, i.e., Zr—O—Zr, further comprising available surface hydroxy groups. These available surface hydroxyl groups are believed to react with the source of an anion of a Group IVB metal, such as tungsten, to form the modified Group IVB metal oxide acidic catalyst component. Precalcination of Zr(OH)₄ at a temperature of from about 100° C. to about 400° C. results in a species which interacts more favorably with tungstate. This precalcination is believed to result in the condensation of ZrOH groups to form a polymeric zirconia species with surface hydroxyl groups. This species resulting from precalcination is referred to herein as a form of a hydrated zirconia.

Treatment of hydrated zirconia with a base solution prior to contact with a source of tungstate may be employed. Further, refluxing hydrated zirconia in an NH₄OH solution having a pH of greater than 7, e.g., about 9, may be employed.

Suitable sources for the oxyanion of the Group VIB metal, such as molybdenum or tungsten, include, but are not limited to, ammonium metatungstate or metamolybdate, tungsten or molybdenum chloride, tungsten or molybdenum carbonyl, tungstic or molybdic acid, and sodium tungstate or molybdate.

The modified Group IVB metal oxide catalyst may be prepared, for example, by impregnating the hydroxide or oxide, particularly the hydrated oxide, of the Group IVB metal with an aqueous solution containing an anion of the Group VIB metal, preferably tungstate or molybdate, followed by drying. Calcination of the resulting modified Group IVB material may be carried out, preferably in an oxidizing atmosphere, at temperatures from about 500° C. to about 900° C. in one embodiment of the invention, from about 700° C. to about 850° C. in another embodiment of the invention, and from about 750° C. to about 825° C. in yet another embodiment of the invention. The calcination time may be up to 48 hours in one embodiment of the invention, for about 0.5-24 hours in another embodiment of the invention, and for about 1.0-10 hours in yet another embodiment of the invention. For example, calcination may be carried out at about 800° C. for about 1 to about 3 hours.

When a source of the hydroxide or hydrated oxide of zirconium is used, calcination, e.g., at temperatures greater than about 500° C., of the combination of this material with a source of an oxyanion of tungsten may be needed to induce the desired degree of acidity to the overall material. However, when more reactive sources of zirconia are used, it is possible that such high calcination temperature may not be needed.

In the modified Group IVB metal oxide catalyst, of the Group IVB oxides, zirconium oxide may be employed; and of the Group VIB anions, tungstate may be employed.

Qualitatively speaking, any conventional method of elemental analysis of the modified Group IVB metal oxide catalyst will reveal the presence of Group IVB metal, Group VIB metal, and oxygen. The amount of oxygen measured in such an analysis will depend on a number of factors, such as the valence state of the Group IVB and Group VIB metals, the form of the hydrogenation/dehydrogenation component, moisture content, etc. Accordingly, in characterizing the composition of the catalyst according to the present invention, it is best not to be restricted by any particular quantities of oxygen. In functional terms, the amount of Group VIB oxyanion in the present catalyst may be expressed as that amount which increases the acidity of the Group IVB oxide. This amount is referred to herein as an acidity increasing amount. Elemental analysis of the present catalyst may be used to determine the relative amounts of Group IVB metal and Group VIB metal in the catalyst. From these amounts, mole ratios in the form of XO₂/YO₃ may be calculated, where X is the Group IVB metal, assumed to be in the form XO₂, and Y is the Group VIB metal, assumed to be in the form of YO₃. It will be appreciated, however, that these forms of oxides, i.e., XO₂ and YO₃, may not actually exist, and are referred to herein simply for the purposes of calculating relative quantities of X and Y in the present catalyst. The present catalysts may have calculated mole ratios, expressed in the form of XO₂/YO₃, where X is at least one Group IVB metal (i.e., Ti, Zr, and Hf) and Y is at least one Group VIB metal (i.e., Cr, Mo, or W), of up to 1000, e.g., up to 300, e.g., from 2 to 100, e.g., from 4 to 30.

In an optional modification of the Group IVB metal oxide described herein, a hydrogenation/dehydrogenation component may be combined with the Group IVB metal oxide, the zeolites, the SAPOs, or the acid clays. This hydrogenation/dehydrogenation component imparts the ability of the material to catalyze the addition of hydrogen to or the removal of hydrogen from organic compounds, such as hydrocarbons, optionally substituted with one or more heteroatoms, such as oxygen, nitrogen, metals or sulfur, when the organic compounds are contacted with the modified material under sufficient hydrogenation or dehydrogenation conditions.

In an embodiment of the invention, the isomerization reaction may be conducted by contacting the feed stock with a fixed stationary bed of catalyst or with a moving bed reactor. As indicated in the examples below, a trickle-bed configuration may be employed. In the trickle-bed configuration, the feed is allowed to trickle through a stationary fixed bed of catalyst during the isomerization reaction of the present invention. Additionally, the isomerization reaction can be carried out in a batch slurry reactor or in a continuous stir tank reactor.

In an embodiment of the invention, during the isomerization reaction an independent source or feed of hydrogen, such as hydrogen gas, may be provided to the isomerization reaction environment. When no hydrogen is sourced or fed to the isomerization reactor, the isomerized PAO will generally be unsaturated. If hydrogen is fed to the isomerization reactor, the isomerized PAO will have a reduced degree of unsaturation. The degree of unsaturation will depend on the amount of hydrogen supplied, the reaction conditions, and the initial unsaturation degree of the PAO feed to the reactor.

### Hydrogenation

As noted above, the oligomerized product may be hydrogenated simultaneously with the isomerization. Alternatively, the isomerized product may be subsequently hydrogenated. The catalyst employed in the isomerization reaction may be carried forward with the isomerized polyolefin to the hydrogenation reaction to subsequently saturate the isomerizated polyolefin.

Any conventional hydrogenation reaction may be employed in the present invention. For example, the hydrogenation process described in U.S. Pat. No. 4,125,569, which is incorporated herein by reference, may be employed in the present invention. Hydrogenation catalysts include, but are not limited to, nickel on Kieselguhr catalyst and conventional metallic hydrogenation catalysts, for example, oxide, hydroxide, or free metal forms of the Group VIII metals, such as cobalt, nickel, palladium, and platinum. The metals are typically associated with carriers such as bauxite, alumina, silica gel, silica-alumina composites, activated carbon, crystalline aluminosilicate zeolites, and clay. Also, non-noble Group VIII metals, metal oxides, and sulfides can be used. Additional examples of catalysts which may be employed in the hydrogenation reaction are disclosed in U.S. Pat. Nos. 3,852,207; 4,157,294; 3,904,513; and 4,673,487, which are incorporated herein by reference. All of the catalysts mentioned above may be employed separately or in combination with one another.

In the hydrogenation reaction, a slight excess to a large excess of hydrogen is used. Unreacted hydrogen may be separated from the hydrogenated polyolefin lube product and recycled to the hydrogenation reaction zone.

### Polyalphaolefin Product

The PAO, following oligomerization and isomerization and optional hydrogenation has a KV₁₀₀ not greater than 20 cSt. In an embodiment of the invention, the KV₁₀₀ of the product is in the range of 1 to 20 cSt, 1.2 to 15 cSt, 1.5 to 15 cSt, 1.5 to 10 cSt, 3 to 15 cSt, or 3 to 10 cSt. In other embodiments of the invention, the PAO has a minimum KV₁₀₀ of 1, 1.2, 1.5, 3, 4, 5, or 6. In other embodiments of the invention, the PAO has a maximum KV₁₀₀ of 20, 18, 15, 10, and 8. In any embodiment of the invention, the PAO may be within a range defined by any one of the above minimum KV values and any one of the above maximum KV values.

The PAOs of the invention have a pour point of less than −20° C. In an embodiment of the invention, the pour point for the PAOs is less than −40° C., less than −55° C., or less than −60° C.

In an embodiment of the invention, the PAOs have a VI above 100, preferably above 110, preferably above 120, preferably above 130, preferably above 140, or preferably above 150. In an embodiment of the invention, the VI is in the range of 120 to 145, 120 to 155, or 120 to 160.

The PAOs of the invention having a KV₁₀₀ of 3 cSt or less with low pour points are useful in the formulation of specialty, fuel/energy efficient transmission or hydraulic fluids. The low viscosity fluids having a KV₁₀₀ of 3 cSt may be useful as high performance, fuel and/or energy efficient base stocks.

### EXAMPLES

The invention may be better understood by reference to the following examples. These examples should be taken only as illustrative of the invention rather than limiting, and one of ordinary skill in the art in possession of the present disclosure would understand that numerous other applications are possible other than those specifically enumerated herein.

In the following examples, KV was determined according to ASTM D445 at the temperature indicated (e.g., 100° C. or −40° C.), VI was determined according to ASTM D-2270, bromine number was determined according to ASTM D1159, and pour point was determined according to ASTM D5950. Gas chromatography (GC) with a mass spectrometer detector, as generally described in “Modern Practice of Gas Chromatography”, R. L. Grob and E. F. Barry, Wiley-Interscience, 3rd Edition (July 1995), was used to analyze product composition.

All synthesis reactions were conducted under inert nitrogen atmosphere.

### Example 1

In a one liter reaction flask with stirrer, zirconocene dichloride (0.102 gram) and 10 wt % methylaluminoxane (MAO) in toluene (20.2 gram) was heated to 40° C. Using a dropping funnel, 1-decene was added slowly over two hours while the reaction temperature of 40° C. was maintained by cooling or heating. The reaction proceeded for 15 hours longer. After removal of the heater, 3 ml of water was added slowly to the reaction mixture, followed by 10 grams of solid alumina. The slurry was stirred for 30 minutes. The crude product was isolated by filtration. GC analysis of the crude product showed 89% decene conversion and with the product containing 69% dimer, 31% trimer, and higher oligomers. The dimer fraction (Example 1A) was separated from the heavier fraction by vacuum distillation; the viscosity and pour point of the dimer fraction are identified in Table 2.

One hundred grams of the dimer fraction was then hydrogenated using 2 wt % of Nickel on kieselguhr catalyst at 175° C. and 5.52 MPa (800 psi) H₂ pressure for 4 hours (Example 1B). Similarly, the heavier fraction from the vacuum distillation was hydrogenated in the same manner as the dimer fraction (Example 1C—see Table 3). This hydrogenated heavier fraction liquid has excellent lubricant properties.

### Example 2

Fifty grams of the dimer fraction of Example 1A was mixed with 0.5 gram of PtZSM-23 catalyst and heated to 265° C. under Nitrogen atmosphere for 8 hours. The product was isolated by filtration. GC analysis of the crude isomerized product show more than 90% selectivity to dimer fraction (Example 2A). This treated dimer fraction was then hydrogenated using 2 wt % of Nickel on kieselguhr catalyst at 175° C. and 5.52 MPa (800 psi) H₂ pressure for 4 hours. The product properties (Example 2B) are summarized in Table 2.

The as-synthesized dimer, and hydrogenated dimer, Examples 1A and 1B, have pour points of 13.6° C. and −22.4° C., respectively; these pour points render the fluid unsuitable for high performance fluid applications that require basestocks having significantly lower pour points. After isomerization and optional hydrogenation, the pour points of the dimer product, Examples 2A and 2B, were reduced to −46.1° C. and −58.4° C., respectively. These lower pour point products are suitable for high performance fluid application. Furthermore, Example 2B has an excellent KV₄₀ of 237.6 cSt, which is better than the same KV₄₀ of 252 cSt of a commercially available low viscosity PAO (“Refa 2 cSt PAO available from ExxonMobil Chemical Company, oligomerized from 1-decene over a Friedel-Crafts catalyst). The data demonstrates the advantages of isomerizing, and optionally hydrogenating, dimer product obtained from a metallocene based oligomerization process.

### Example 3

A reaction mixture of 200 gram of purified 1-decene, 20.8 gram of tri-isobutylaluminum (TIBA) stock solution (20 mg TIBA/g solution) and 7.12 gram of a metallocene (bis[tetramethylcyclopentadienyl]dichloride, 1 mg/g solution) was charged into a 600 ml high pressure vessel under nitrogen atmosphere. The vessel was charged with 0.21 MPa (30 psi) H₂ and heated to 110° C. At reaction temperature, a catalyst activator solution containing 20 gram toluene and 10.256 gram of an activator stock solution (N,N-dimethylanilinium tetrakis(pentafluoroboron), 1 mg/g solution). After 15 hours, the reaction was cooled down, vented, and 2 ml of isopropanol was added to the mixture. The reaction mixture was then worked up in a manner similar to that of Example 1. The dimer fraction (Example 3A) was separated from the total product and its properties are summarized in Table 2. The heavier fraction (Example 3B) was also analyzed for its lubricant properties which are summarized in Table 3.

### Example 4

The dimer fraction of Example 3 was then treated in the same manner as the dimer fraction of Example 2, except using a different catalyst PtZSM-48 at 160° C. This treated dimer was then hydrogenated at 80° C. using a 5% Pd on Activated Carbon catalyst at 80° C., 5.52 MPa (800 psi) hydrogen pressure for 16 hours. The properties of the treated dimer (Example 4A) and hydrogenated treated dimer (Example 4B) are summarized in Table 2.

TABLE 2

| Example No. | 1A | 1B | 2A | 2B | 3A | 4A | 4B | SpectraSyn ™ 2 |
|---|---|---|---|---|---|---|---|---|
| Kv 100° C., cSt | 1.7 | 1.77 | | 1.8 | 1.68 | 2.04 | 2.55 | 1.7 |
| Kv 40° C., cSt | | 4.98 | | 5.25 | 4.44 | 5.86 | 9.76 | 5 |
| VI | | 139 | | 123 | | | | — |
| Pour Point, ° C. | 13.6 | −22.4 | −46.1 | −58.4 | −21 | −65 | −60 | −66 |
| Kv −40° C., cSt | | nm* | | 237.6 | | | | 252 |

*nm = not measureable

The as-synthesized dimer of Example 3 has a pour point of −21° C. The treated dimer and hydrogenated treated dimer, examples 4A and 4B, have much lower pour points of −65 and −60° C., respectively. Again, the data demonstrate the improvement in the dimer fraction by isomerizing the dimer and thereby obtaining a PAO having desirable lubricant properties.

The heavier tetramer+ product properties obtained from the above described oligomerization examples, even when not further isomerized either alone or with the dimer fractions, are useful as lube products. The properties of the tetramer+ products are provided in Table 3 below.

TABLE 3

| Example No. | 1C | 3B |
|---|---|---|
| Kv 100° C., cSt | 4.86 | 3.90 |
| Kv 40° C., cSt | 21.91 | 15.97 |
| VI | 153 | 144 |
| Pour Point, ° C. | −66 | −65 |

### Example 5

A 600 ml autoclave was cleaned, heated to 110° C. with a purging nitrogen stream overnight and cooled down to room temperature under N₂ atmosphere. A solution containing 200 gram purified 1-tetradecene, 5.204 gram TIBA solution (25 mg TIBA/g toluene solution) and 1.78 gram metallocene solution (1 mg of bis(tetramethylcyclopentadienyl)zirconium dichloride/g toluene solution) was charged into the autoclave. This solution was heated to 120° C. with stirring. The reactor was pressurized with H₂ to 0.7 MPa (100 psi), followed by the addition of a solution containing 20 gram toluene and 1.78 gram activator solution (1 mg of N,N-dimethylanilinium tetrakis(pentafluoroboron)/g toluene solution). At the end of 16 hours of reaction, the reactor was cooled to room temperature, vented to atmosphere and 3 ml of isopropanol was added to quench the reactor. 10 grams of activated alumina was added to remove catalyst residual. The raw product was isolated by filtering off the solid. The conversion of 1-tetradecene was 53% with the product containing both dimer and higher oligomers, as analyzed by gas chromatograph. The lube fraction containing tetradecene dimer and higher fraction was isolated by distillation under vacuum to remove any unreacted tetradecene and other light fractions. The properties of the lube fractions are summarized in Table 4.

### Example 6

Twenty grams of the Example 5 lube fraction and 1 gram of a PtZSM48 catalyst (MZ-91) were mixed in a round bottom flask, purged with N₂ gas and heated to 250° C. for 16 hours. The reaction mixture was cooled down to room temperature and filtered to isolate the lube. The lube properties are summarized in Table 4. As the data show, isomerization of the product significantly improves the pour point of the fluid from +18° C. to −24° C.

### Examples 7 to 9

The isomerization of 20 grams of product from Example 5 was completed in a manner similar to Example 6, except the reaction temperatures were varied from 260° C. to 280° C. The pour point of the isomerized fluids are set forth in Table 4. All Examples 6 to 9 fluids still maintained a very high VI, ranging from 136 to 155.

### Example 10

A twenty gram sample of fluid from Example 7 and 1 gram of a 5 wt % Pd on activated carbon catalyst (from Aldrich Chemical Co., a company with a business office in Milwaukee, Wis.) were charged into an autoclave. The autoclave was purged with hydrogen to remove air, then heated to 80° C. and pressurized with hydrogen to 5.52 MPa (800 psi) for 16 hours with stirring. The reaction was terminated by venting the reactor and cooled down to room temperature. The hydrogenated lube was isolated by filtration to remove solid catalyst. The hydrogenated lube properties are summarized in Table 4.

### Example 11

Similar to Example 10, except twenty grams of fluid from Example 8 was used for the hydrogenation. The properties of the hydrogenated isomerized product are summarized in Table 4.

Examples 10 and 11 demonstrate that the treated samples maintain excellent low pour points after full hydrogenation.

TABLE 4

| Example No. | 5 | 6 | 7 | 8 | 9 | 10 | 11 |
|---|---|---|---|---|---|---|---|
| Isom Temp., ° C. | N/A | 250 | 260 | 270 | 280 | 260 | 270 |
| 100° C. Kv, cSt | 4.07 | 4.19 | 4.62 | 3.87 | 4.31 | 4.75 | nm |
| 40° C. Kv, cSt | 15.14 | 17.2 | 21.32 | 16.25 | 19.13 | 23.61 | nm |
| VI | 183 | 155 | 137 | 135 | 136 | 122 | nm |
| Bromine Number | 40.2 | 40.7 | 35 | 40.9 | 29 | 5.1 | 6.5 |
| Pour Point, ° C. | 18 | −24 | −42 | −36 | −46 | −42 | −46 |

nm = not measured

### Example 12

### Tetradecene Feed

Example 5 was repeated. Properties of the product are summarized in Table 5.

### Example 13

Example 6 was repeated using Example 12 as the starting material. Properties of the isomerized product are set forth in Table 5.

### Examples 14 and 15

Example 13 was repeated, except the reaction temperature was increased to 260° C. and 270° C., respectively. Properties of the isomerized products are set forth in Table 5.

TABLE 5

| Example No. | 12 | 13 | 14 | 15 |
|---|---|---|---|---|
| Isom Temp., ° C. | n/a | 250 | 260 | 270 |
| 100° C. Kv, cSt | 3.92 | 5.09 | 4.85 | 4.62 |
| 40° C. Kv, cSt | 14.34 | 24.05 | 22.43 | 21.58 |
| VI | 183 | 146 | 144 | 134 |
| Bromine Number | 45.2 | 37.6 | 37.1 | 32.5 |
| Pour Point, ° C. | +25 | −26 | −34 | −30 |

Examples 13 to 15 further demonstrate that the polymerization of alpha-olefins followed by isomerization produced fluids with high VI and very low pour points.

### Example 16

### Mixed Feed

A 600 ml autoclave was thoroughly cleaned, heated to 110° C. with purging nitrogen stream overnight and cooled down to room temperature under N₂ atmosphere. A solution containing 100 gram purified 33.3 gram 1-hexene, 33.3 gram 1-decene and 33.3 gram 1-tetradecene, 6.50 gram TIBA solution (25 mg TIBA/g toluene solution) and 1.6 gram metallocene solution (1 mg of bis(tetramethylcyclopentadienyl)zirconium dichloride/g toluene solution) was charged into the autoclave. This solution was heated to 100° C. with stirring. The reactor was pressurized with H₂ to 0.21 MPa (30 psi), followed by the addition of a solution containing 20 gram toluene and 3.17 gram activator solution (1 mg of N,N-dimethylanilinium tetrakis(pentafluoroboron)/g toluene solution). At the end of 16 hours of reaction, the reactor was cooled down to room temperature, vented to atmosphere and 10 gram of activated alumina was added to remove catalyst residual. The raw product was isolated by filtering off the solid. The lube fraction containing boiling fractions higher than 371° C. (700° F.) was isolated by distillation under vacuum to remove any olefins and other light fractions. The properties of the lube fraction are summarized in Table 6.

### Example 17

Example 6 was repeated, except using the lube product of Example 16 as the feed and the isomerization temperature was increased to 260° C. Properties of the isomerized product are set forth in Table 6.

### Example 18

Similar to Example 16, except the following components were charged into reactor: 180 gram of purified 1-dodecene and 16.0 gram of tri-n-octylaluminum solution (20 mg of TNOAL/g toluene solution), a catalyst solution containing 6.4 gram metallocene solution (1 mg of bis(1-methyl-3-n-butylcyclopendienyl)zirconium dimethyl/g toluene solution), 15.3 gram activator solution (1 mg of N,N-dimethylanilinium tetrakis(pentafluoroboron)/g toluene solution), 2.0 gram TNOAL solution, and 20 gram toluene. The reactor was heated to 125° C. with 0.14 MPa (20 psi) hydrogen pressure. Properties of the lube fraction are set forth in Table 6.

### Example 19

Example 6 was repeated, except using Example 18 as the feed and the isomerization temperature was increased to 260° C. Properties of the lube fraction are set forth in Table 6.

TABLE 6

| Example No. | 16 | 17 | 18 | 19 |
|---|---|---|---|---|
| 100° C. Kv, cSt | 3.8 | 3.76 | 3.32 | 3.8 |
| 40° C. Kv, cSt | 14.83 | 15.69 | 11.64 | 16.27 |
| VI | 154 | 132 | 169 | 127 |
| Bromine Number | 38.1 | 41.2 | — | 40 |
| Pour Point, ° C. | −2 | −60 | −15 | −55 |

Examples 16 to 19 demonstrated that the same process works well with lube fractions prepared from C₆, C₁₀, C₁₄ mixed olefins or from lube fractions (containing dimer and higher oligomers) from C₁₂ LAO.

Accordingly, the present disclosure relates to the following inventions:

A. A process to prepare a polyalphaolefin having a KV₁₀₀ of between 1 cSt and 20 cSt, the process comprising: contacting a single-site metallocene catalyst system with a feedstock comprising one or more monomers selected from C₄ to C₂₄ alpha-olefins to form a polyalphaolefin product mixture; isomerizing at least a portion of the polyalphaolefin product mixture in the presence of an acid catalyst to form an isomerized polyalpholefin; and optionally hydrogenating the isomerized polyalphaolefin.
B. The process according to paragraph A, wherein feedstock consists of at least two alpha-olefin monomers selected from 1-butene, 1-hexene, 1-octene, 1-nonene, 1-decene, 1-dodecene, 1-tetradecene, 1-hexadecene, and 1-octadecene.
C. The process according to paragraph A, wherein the feedstock consists of a single monomer selected from the group consisting of 1-octene, 1-nonene, 1-decene, 1-dodecene, and 1-tetradecene.
D. The process according to any one or any combination of paragraphs A to C, wherein the single-site metallocene catalyst system consists of a single-site metallocene compound and at least one activator.
E. The process according to paragraph D, wherein the metallocene compound is bridged or unbridged and contains a Group 4 transition metal.
F. The process according to paragraph D or E, wherein the activator is a non-coordinating anion activator or a trialkyl aluminum compound.
G. The process according to any one or any combination of paragraphs D to F, wherein the catalyst system comprises an activator and a co-activator.
H. The process according to any one or any combination of paragraphs A to G, wherein the acid catalyst is selected from the group consisting of zeolites, Friedel-Crafts catalysts, Bronsted acids, Lewis acids, acidic resins, acidic solid oxides, acidic silicoaluminophosphates, Group IVB metal oxides, Group VB metal oxides, Group VIB metal oxides, hydroxide or free metal forms of Group VIII metals, and any combination thereof
I. The process according to any one or any combination of paragraphs A to H, wherein the acid catalyst is a zeolite catalyst having a Constraint Index of about 12 or less.
J. The process according to any one or any combination of paragraphs A to I, wherein the polyalphaolefin has a KV₁₀₀ of between 1.5 cSt and 10 cSt.
K. The process according to any one or any combination of paragraphs A to I, wherein the polyalphaolefin has a KV₁₀₀ of between 3 cSt and 20 cSt.
L. The process according to any one or any combination of paragraphs A to K, wherein the polyalphaolefin product mixture comprises 5 to 80 wt % dimer of the feedstock monomers.
M. The process according to any one or any combination of paragraphs A to L, the process further comprising fractionating the polyalphaolefin product mixture to obtain a portion of the mixture wherein the portion is at least 80 wt % dimer of the feedstock monomers.
N. The process according to any one or any combination of paragraphs A to M, wherein the pour point of the isomerized polyalphaolefin is at least 20° C. less than prior to isomerization.
O. The process according to any one or any combination of paragraphs A to N, wherein said contacting occurs in the absence of H₂.

Unless stated otherwise herein, the meanings of terms used herein shall take their ordinary meaning in the art; and reference shall be taken, in particular, to Synthetic Lubricants and High-Performance Functional Fluids, Second Edition, Edited by Leslie R. Rudnick and Ronald L. Shubkin, Marcel Dekker (1999). This reference, as well as all patents and patent applications, test procedures (such as ASTM methods and the like), and other documents cited herein are fully incorporated by reference to the extent such disclosure is not inconsistent with this invention and for all jurisdictions in which such incorporation is permitted. Note that Trade Names used herein are indicated by a ™ symbol or ® symbol, indicating that the names may be protected by certain trademark rights, e.g., they may be registered trademarks in various jurisdictions. Note also that when numerical lower limits and numerical upper limits are listed herein, ranges from any lower limit to any upper limit are contemplated.

Although the invention has been described in detail for the purpose of illustration, it is understood that such detail is solely for that purpose, and variations can be made therein by those skilled in the art without departing from the spirit and scope of the invention which is defined by the following claims.

What is claimed is:

1. A process to prepare a polyalphaolefin having a kinematic viscosity at 100° C. of between 1 cSt and 20 cSt, the process comprising:
contacting a single-site metallocene catalyst system with a feedstock comprising one or more monomers selected from C₄ to C₂₄ alpha olefins to form a polyalphaolefin product mixture;
isomerizing at least a portion of the polyalphaolefin product mixture in the presence of an acid catalyst to form an isomerized polyalpholefin; and
optionally hydrogenating the isomerized polyalphaolefin.

2. The process according to claim 1, wherein feedstock consists of at least two alpha-olefin monomers selected from 1-butene, 1-hexene, 1-octene, 1-nonene, 1-decene, 1-dodecene, 1-tetradecene, 1-hexadecene, and 1-octadecene.

3. The process according to claim 1, wherein the feedstock consists of a single monomer selected from the group consisting of 1-octene, 1-nonene, 1-decene, 1-dodecene, and 1-tetradecene.

4. The process according to claim 1, wherein the single-site metallocene catalyst system consists of a single-site metallocene compound and at least one activator.

5. The process according to claim 4, wherein the metallocene compound is bridged or unbridged and contains a Group 4 transition metal.

6. The process according to claim 4, wherein the activator is a non-coordinating anion activator or a trialkyl aluminum compound.

7. The process according to claim 4, wherein the catalyst system comprises an activator and a co-activator.

8. The process according to claim 1, wherein the acid catalyst is selected from the group consisting of zeolites, Friedel-Crafts catalysts, Bronsted acids, Lewis acids, acidic resins, acidic solid oxides, acidic silicoaluminophosphates, Group IVB metal oxides, Group VB metal oxides, Group VIB metal oxides, hydroxide or free metal forms of Group VIII metals, and any combination thereof.

9. The process according to claim 1, wherein the acid catalyst is a zeolite catalyst having a Constraint Index of about 12 or less.

10. The process according to claim 1, wherein the polyalphaolefin has a kinematic viscosity at 100° C. of between 1.5 cSt and 10 cSt.

11. The process according to claim 1, wherein the polyalphaolefin has a kinematic viscosity at 100° C. of between 3 cSt and 20 cSt.

12. The process according to claim 1, wherein the polyalphaolefin product mixture comprises 5 to 80 wt % dimer of the feedstock monomers.

13. The process according to claim 1, the process further comprising fractionating the polyalphaolefin product mixture to obtain a portion of the mixture wherein the portion is at least 80 wt % dimer of the feedstock monomers.

14. The process according to claim 1, wherein the pour point of the isomerized polyalphaolefin is at least 20° C. less than prior to isomerization.

15. The process according to claim 1, wherein said contacting occurs in the absence of H₂.
